(19) United States
(12) Patent Application Publication
(10) Pub. No.: US 2025/0219325 A1
(43) Pub. Date: Jul. 3, 2025

(54) PULL STRAP CONNECTOR WITH DOUBLE-SIDED UNLOCKING STRUCTURE AND CONNECTOR ASSEMBLY HAVING THE SAME

(71) Applicant: DONGGUAN LUXSHARE TECHNOLOGIES CO., LTD, Dongguan City, Guangdong Province (CN)

(72) Inventors: Xuzong HUANG, Dongguan City (CN); Sihai YI, Dongguan City (CN); Zhaolong ZENG, Dongguan City (CN); Kaide WANG, Dongguan City (CN); Qiongnan CHEN, Dongguan City (CN)

(73) Assignee: DONGGUAN LUXSHARE TECHNOLOGIES CO., LTD, Dongguan City, Guangdong Province (CN)

(21) Appl. No.: 18/776,669

(22) Filed: Jul. 18, 2024

(30) Foreign Application Priority Data
Jan. 2, 2024 (CN) 202410012064.7

(51) Int. Cl. H01R 13/633; H01R 13/627

(52) U.S. Cl. CPC H01R 13/633; H01R 13/6275

(57) ABSTRACT

A pull strap connector includes an insulating body, a first locking piece, a second locking piece and a pull strap. The insulating body includes a first side wall and a second side wall. The first locking piece is at least partially mounted to the first side wall. The first locking piece includes a first locking hook portion. The second locking piece is at least partially mounted to the second side wall. The second locking piece includes a second locking hook portion. The pull strap is configured to be pulled by an external force, so that the first locking hook portion and the second locking hook portion are unlocked from a mating connector. A connector assembly having the pull strap connector is also disclosed.

### CROSS-REFERENCE TO RELATED APPLICATION

This patent application claims priority of a Chinese Patent Application No. 202410012064.7, filed on Jan. 2, 2024 and titled “PULL STRAP CONNECTOR AND CONNECTOR ASSEMBLY”, the entire content of which is incorporated herein by reference.

### TECHNICAL FIELD

The present disclosure relates to a pull strap connector and a connector assembly, which belong to the technical field of connectors.

### BACKGROUND

Connector assemblies in the related art include mating connectors and pull strap connectors. The mating connector is generally mounted on a circuit board as a receptacle connector. The pull strap connector generally includes a cable and acts as a plug connector.

As the requirements for the connector assemblies in certain application scenarios become higher and higher, how to improve the reliability of pull strap connectors and mating connectors during mating is becoming increasingly important.

For this reason, in the related art, there is a design in which a locking hook portion is provided on the pull strap connector, and a locking hole matching the locking hook portion is provided on the mating connector. However, such design in the related art is generally provided with the locking hook portion only on one side of the pull strap connector. The main problem caused by this single-sided locking design is that the side without the locking hook portion is easily skewed due to external forces, resulting in an instantaneous signal interruption.

### SUMMARY

An object of the present disclosure is to provide a pull strap connector and a connector assembly that are structurally reliable and facilitate unlocking.

In order to achieve the above object, the present disclosure adopts the following technical solution: a pull strap connector, configured to mate with a mating connector, including: an insulating body, the insulating body including a first side wall and a second side wall opposite to the first side wall; a first locking piece, the first locking piece being at least partially mounted to the first side wall; the first locking piece including a first locking hook portion configured to lock with the mating connector; a second locking piece, the second locking piece being at least partially mounted to the second side wall; the second locking piece including a second locking hook portion configured to lock with the mating connector; and a pull strap, the pull strap directly or indirectly driving the first locking piece and the second locking piece; wherein the pull strap is configured to be pulled by an external force, so that the first locking hook portion and the second locking hook portion are unlocked from the mating connector.

In order to achieve the above object, the present disclosure adopts the following technical solution: a connector assembly, including: a pull strap connector including: an insulating body; a first locking piece including a first locking hook portion configured to lock with the mating connector; a second locking piece including a second locking hook portion configured to lock with the mating connector; the first locking hook portion and the second locking hook portion being located on opposite sides of the insulating body, respectively; and a pull strap directly or indirectly driving the first locking piece and the second locking piece to deform; and a mating connector including: a shell including a first wall portion and a second wall portion opposite to the first wall portion; the first wall portion defining a first locking hole that matches the first locking hook portion; the second wall portion defining a second locking hole that matches the second locking hook portion; and a receiving slot configured to receive at least part of the pull strap connector; wherein the pull strap is configured to be pulled by an external force, so that the first locking hook portion and the second locking hook portion are unlocked from the mating connector.

Compared with the prior art, the pull strap connector of the present disclosure is provided with the first locking hook portion and the second locking hook portion on two sides, thereby improving the reliability when the pull strap connector is mated with the mating connector. Besides, the pull strap can elastically deform the first locking piece and the second locking piece under the action of the external force, so that the first locking hook portion and the second locking hook portion are unlocked simultaneously from the mating connector.

### BRIEF DESCRIPTION OF DRAWINGS

FIG. 1 is a perspective view of a connector assembly in accordance with a first embodiment of the present disclosure, in which a pull strap connector and a mating connector are in a locked state;

FIG. 2 is a perspective view of FIG. 1 from another angle;

FIG. 3 is a partially exploded perspective view of FIG. 1, in which the pull strap connector and the mating connector are separated from each other;

FIG. 4 is a partially exploded perspective view of FIG. 3 from another angle;

FIG. 5 is a partially exploded perspective view of the pull strap connector in accordance with a first embodiment of the present disclosure, in which a first pressing block is separated;

FIG. 6 is a further partial perspective exploded view of FIG. 5;

FIG. 7 is a partially exploded perspective view of FIG. 6 from another angle;

FIG. 8 is a perspective view of a driving element and a pull strap in FIG. 6 when they are connected together and in a locking position;

FIG. 9 is a perspective view of FIG. 8 from another angle;

FIG. 10 is a further partially exploded perspective view of FIG. 6;

FIG. 11 is a partially exploded perspective view of FIG. 10 from another angle;

FIG. 12 is an exploded perspective view of FIG. 8;

FIG. 13 is an exploded perspective view of FIG. 12 from another angle;

FIG. 14 is an exploded perspective view of an insulating body, a cable module and a locking member of the pull strap connector in accordance with a first embodiment of the present disclosure;

FIG. 15 is a partially exploded perspective view of the mating connector in accordance with a first embodiment of the present disclosure;

FIG. 16 is a partially exploded perspective view of FIG. 15 from another angle;

FIG. 17 is a left view of FIG. 1;

FIG. 18 is a right view of FIG. 1;

FIG. 19 is a left view of FIG. 3;

FIG. 20 is a right view of FIG. 4;

FIG. 21 is a schematic cross-sectional view taken along line A-A in FIG. 1;

FIG. 22 is a schematic cross-sectional view taken along line B-B in FIG. 1;

FIG. 23 is a perspective view of the connector assembly in accordance with the first embodiment of the present disclosure, in which the pull strap connector and the mating connector are in an unlocked state;

FIG. 24 is a perspective view of FIG. 23 from another angle;

FIG. 25 is a left view of FIG. 23;

FIG. 26 is a right view of FIG. 23;

FIG. 27 is a perspective view of the driving element and the pull strap in FIG. 23 when they are connected together and in an unlocked position;

FIG. 28 is a perspective view of FIG. 27 from another angle;

FIG. 29 is a perspective view of a connector assembly in accordance with a second embodiment of the present disclosure, in which a pull strap connector and a mating connector are in a locked state;

FIG. 30 is a perspective view of FIG. 29 from another angle;

FIG. 31 is a partial perspective view of FIG. 29;

FIG. 32 is a perspective view of a driving element and a pull strap in FIG. 29 when they are connected together and in a locking position;

FIG. 33 is an exploded perspective view of FIG. 32;

FIG. 34 is a perspective view of the connector assembly in accordance with the second embodiment of the present disclosure, in which the pull strap connector and the mating connector are in an unlocked state;

FIG. 35 is a perspective view of FIG. 34 from another angle;

FIG. 36 is a partially exploded perspective view of FIG. 35;

FIG. 37 is a perspective view of the driving element and the pull strap in FIG. 36 when they are connected together and in an unlocking position;

FIG. 38 is a front view of FIG. 37, and hollow arrows indicate a force direction of the pull strap and deformation directions of the first locking piece and the second locking piece; and

FIG. 39 is a schematic perspective view of the driving element and the pull strap when they are connected together and in the locking position in another embodiment, in which hollow arrows indicate a force direction of the pull strap and sliding directions of the first moving rod and the second moving rod when unlocked.

### DETAILED DESCRIPTION

Exemplary embodiments will be described in detail here, examples of which are shown in drawings. When referring to the drawings below, unless otherwise indicated, same numerals in different drawings represent the same or similar elements. The examples described in the following exemplary embodiments do not represent all embodiments consistent with this application. Rather, they are merely examples of devices and methods consistent with some aspects of the application as detailed in the appended claims.

The terminology used in this application is only for the purpose of describing particular embodiments, and is not intended to limit this application. The singular forms “a”, “said”, and “the” used in this application and the appended claims are also intended to include plural forms unless the context clearly indicates other meanings.

It should be understood that the terms “first”, “second” and similar words used in the specification and claims of this application do not represent any order, quantity or importance, but are only used to distinguish different components. Similarly, “an” or “a” and other similar words do not mean a quantity limit, but mean that there is at least one; “multiple” or “a plurality of” means two or more than two. Unless otherwise noted, “front”, “rear”, “lower” and/or “upper” and similar words are for ease of description only and are not limited to one location or one spatial orientation. Similar words such as “include” or “comprise” mean that elements or objects appear before “include” or “comprise” cover elements or objects listed after “include” or “comprise” and their equivalents, and do not exclude other elements or objects. The term “a plurality of” mentioned in the present disclosure includes two or more.

Hereinafter, some embodiments of the present disclosure will be described in detail with reference to the accompanying drawings. In the case of no conflict, the following embodiments and features in the embodiments can be combined with each other.

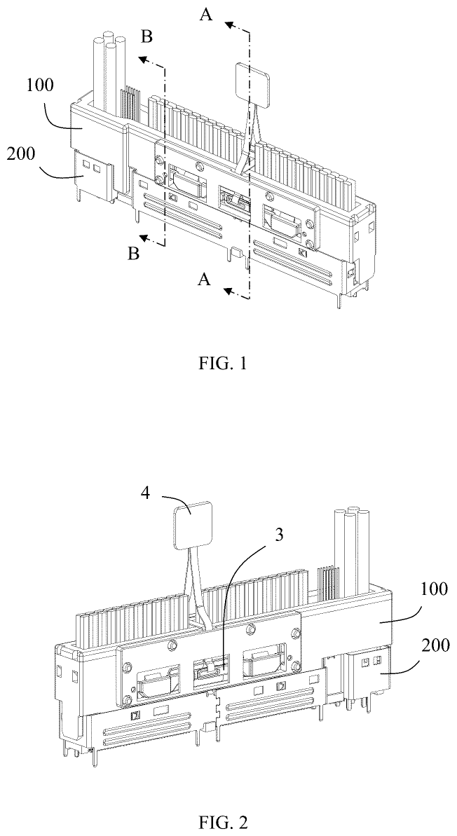

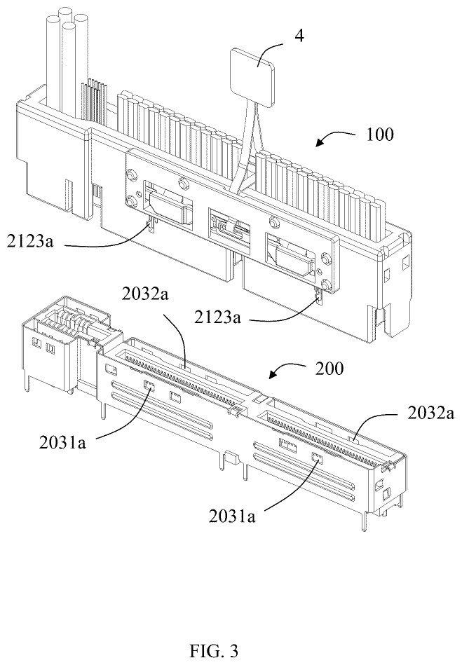

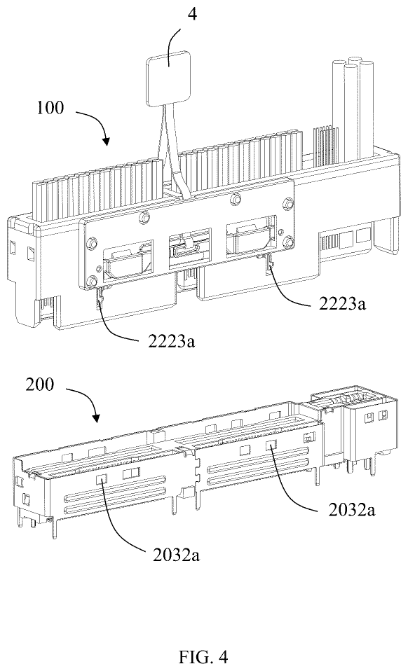

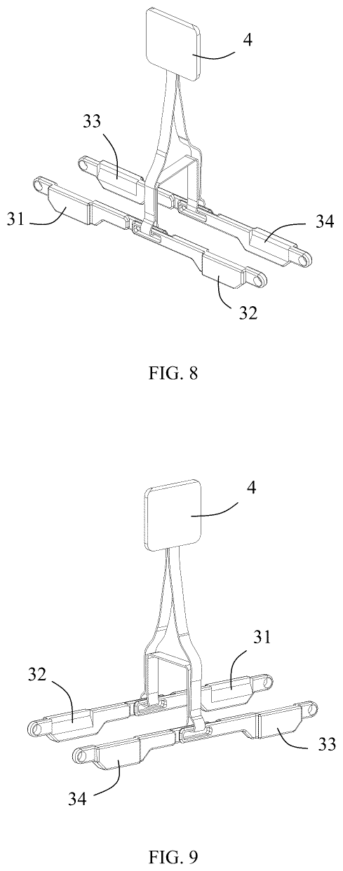

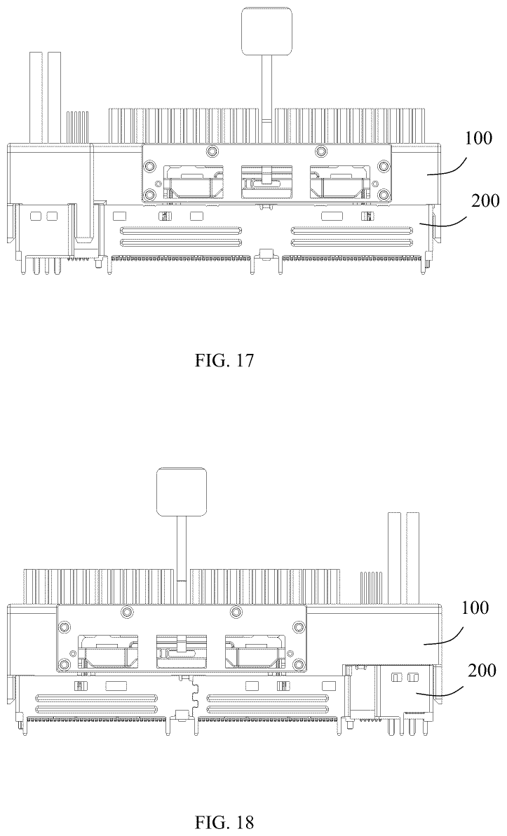

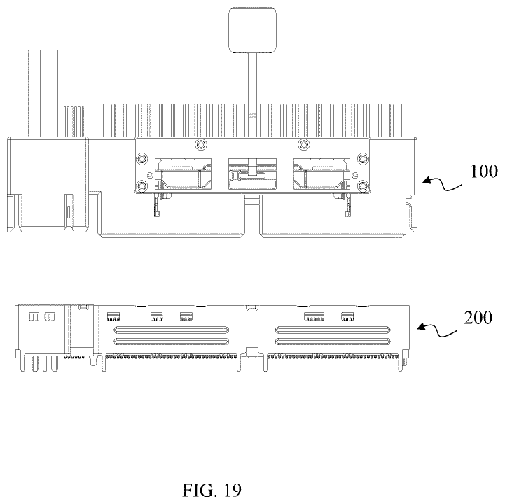

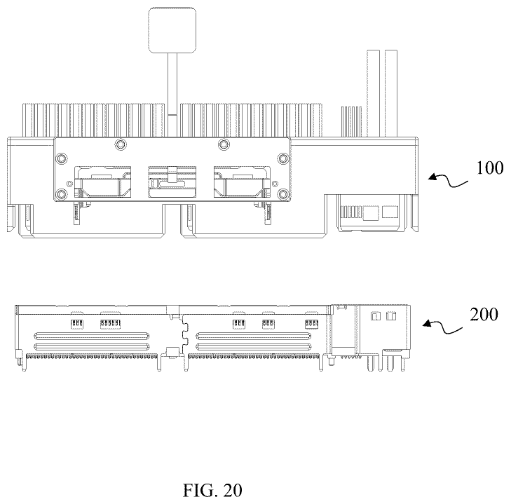

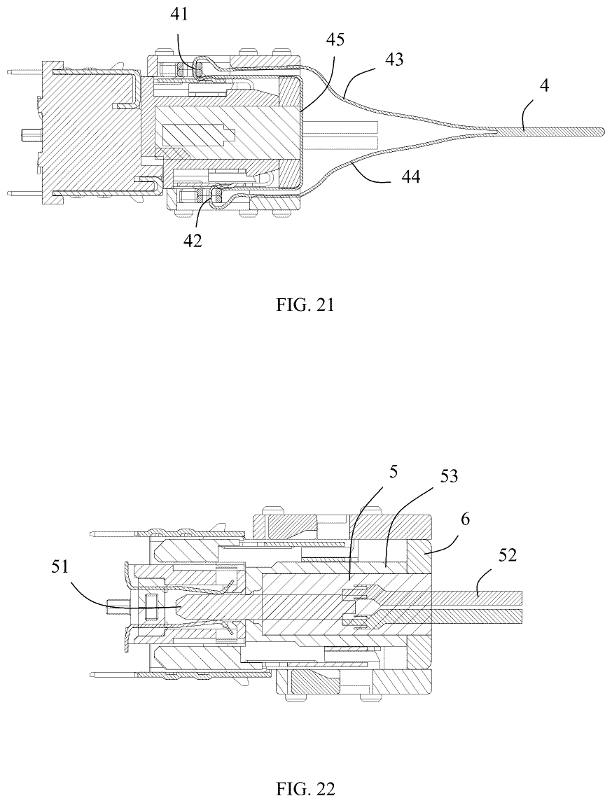

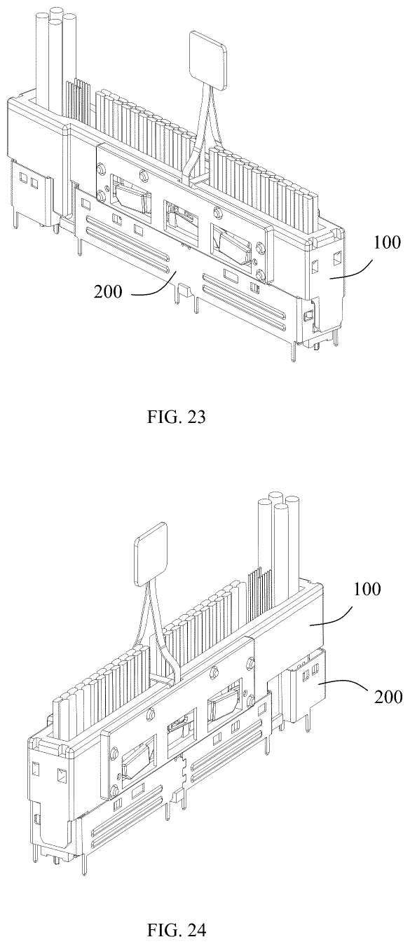

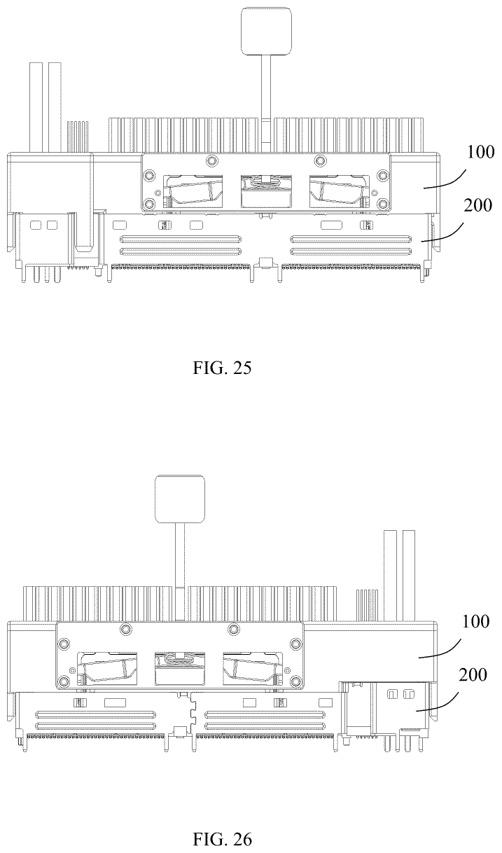

Referring to FIG. 1 to FIG. 28, a first embodiment of the present disclosure discloses a connector assembly, which includes a mating connector 200 and a pull strap connector 100 configured to mate with the mating connector 200 to transmit data and/or power. In one embodiment of the present disclosure, the mating connector 200 is used to be installed on a circuit board (not shown).

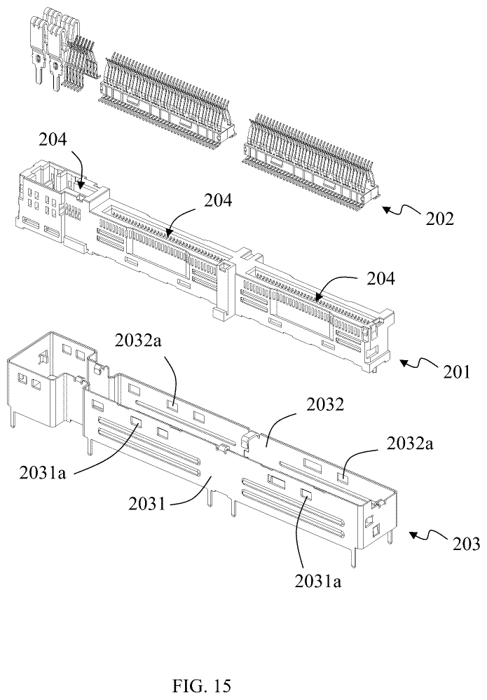

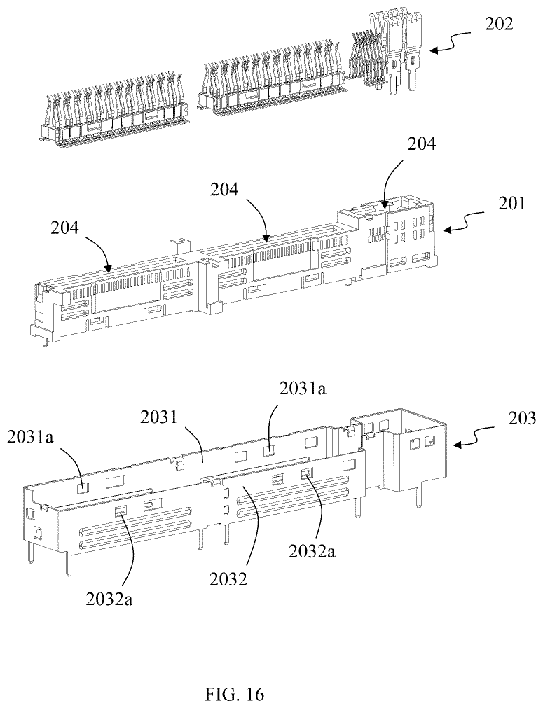

Referring to FIG. 1 to FIG. 4, FIG. 15 and FIG. 16, the mating connector 200 includes an insulating body portion 201, a plurality of terminal modules 202 mounted to the insulating body portion 201, and a shell 203 enclosing the insulating body portion 201. The insulating body portion 201 defines a receiving slot 204 for receiving at least part of the pull strap connector 100. The shell 203 may be made of metal material and includes a first wall portion 2031 and a second wall portion 2032 opposite to the first wall portion 2031. The first wall portion 2031 and the second wall portion 2032 are wide sides of the shell 203. The first wall portion 2031 defines a first locking hole 2031a. The second wall portion 2032 defines a second locking hole 2032a.

Referring to FIG. 1 to FIG. 11, in a first embodiment of the present disclosure, the pull strap connector 100 includes an insulating body 1, a first locking piece 21, a second locking piece 22, a driving element 3, a pull strap 4, a cable module 5 and a locking member 6. In the illustrated embodiment of the present disclosure, the first locking piece 21 and the second locking piece 22 are installed on the insulating body 1.

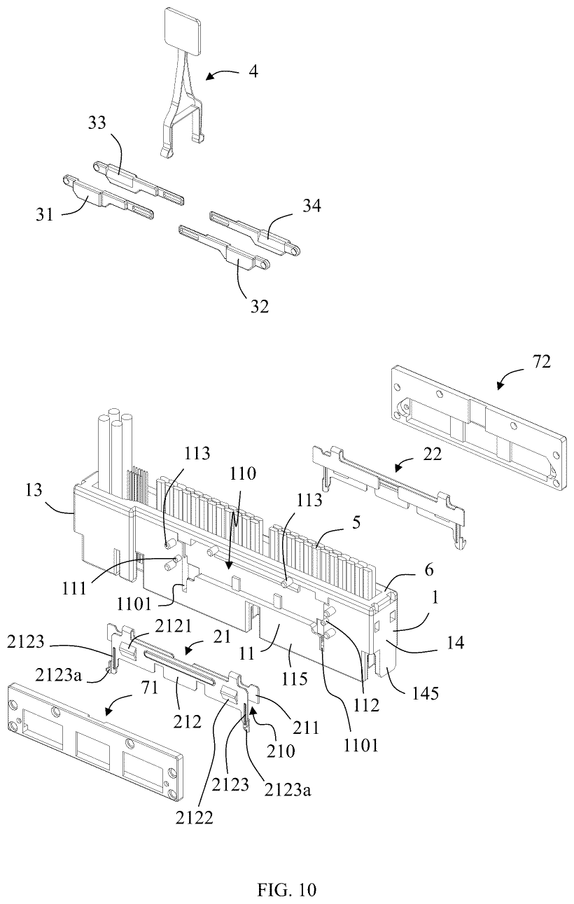

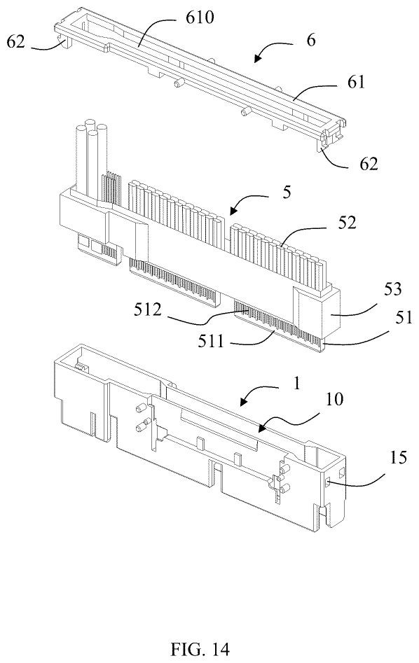

Referring to FIG. 10, FIG. 11 and FIG. 14, in the illustrated embodiment of the present disclosure, the insulating body 1 includes a first side wall 11 and a second side 13 opposite to the first side wall 11, a third side wall 13, a fourth side wall 14 opposite to the third side wall 13, and an installation groove 10 jointly surrounded by the first side wall 11, the second side wall 12, the third side wall 13 and the fourth side wall 14. In the illustrated embodiment of the present disclosure, the insulating body 1 is generally in the shape of a rectangular parallelepiped. The first side wall 11 and the second side wall 12 are the long sides of the rectangular parallelepiped. The third side wall 13 and the fourth side wall 14 are the short sides of the rectangular parallelepiped.

In the illustrated embodiment of the present disclosure, the insulating body 1 further includes a first mounting protruding plate 115 extending downwardly from the first side wall 11, a second mounting protruding plate 125 extending downwardly from the second side wall 12, a third mounting protruding plate 135 extending downwardly from the third side wall 13, and a fourth mounting protruding plate 145 extending downwardly from the fourth side wall 14.

In the illustrated embodiment of the present disclosure, the first side wall 11 defines a first installation space 110 for installing the first locking piece 21. The second side wall 12 defines a second installation space 120 for installing the second locking piece 22. The first installation space 110 includes two first slots 1101 on two sides thereof. The second installation space 120 includes two second slots 1201 on two sides thereof. In addition, the first side wall 11 is also provided with a first protruding post 111 protruding outwardly, a second protruding post 112 protruding outwardly, and a plurality of first mounting posts 113 protruding outwardly. In the illustrated embodiment of the present disclosure, the first protruding post 111, the second protruding post 112 and the first mounting posts 113 are distributed around the first installation space 110. The first protruding post 111 and the second protruding post 112 are located on two sides of the first installation space 110, respectively.

The second side wall 12 is provided with a third protruding post 121 protruding outwardly, a fourth protruding post 122 protruding outwardly, and a plurality of second mounting posts 123 protruding outwardly. In the illustrated embodiment of the present disclosure, the third protruding post 121, the fourth protruding post 122 and the second mounting posts 123 are distributed around the second installation space 120. The third protruding post 121 and the fourth protruding post 122 are located on two sides of the second installation space 120, respectively.

Referring to FIG. 10, in the first embodiment of the present disclosure, the first locking piece 21 is formed by stamping and bending a metal sheet. The first locking piece 21 is generally U-shaped and includes a first fixing portion 211, a first base portion 212 folded from one side of the first fixing portion 211, and a first deformation space 210 located between the first fixing portion 211 and the first base portion 212. Most of the first base portion 212 and the first fixing portion 211 are overlapped. The first fixing portion 211 is installed in the first installation space 110 of the first side wall 11. Under the action of an external force, the first base portion 212 can elastically deform relative to the first fixing portion 211.

In the first embodiment of the present disclosure, the first base portion 212 includes a first protrusion 2121, a second protrusion 2122, and two first locking arms 2123 located outside the first protrusion 2121 and the second protrusion 2122. In the first embodiment illustrated in the present disclosure, the first protrusion 2121 and the second protrusion 2122 are located on two sides of the first base portion 212, respectively. Each first locking arm 2123 is integrally formed with the first base portion 212 (for example, stamped in one piece). Each first locking arm 2123 is provided with a first locking hook portion 2123a configured to lock with the mating connector 200. The first locking arm 2123 is received in a corresponding first slot 1101 and is deformable to a certain extent in the corresponding first slot 1101.

Similarly, as shown in FIG. 11, in the first embodiment of the present disclosure, the second locking piece 22 is formed by stamping and bending a metal sheet. The second locking piece 22 is generally U-shaped, and includes a second fixing portion 221, a second base portion 222 folded from one side of the second fixing portion 221, and a second deformation space 220 located between the second fixing portion 221 and the second base portion 222. Most of the second base portion 222 and the second fixing portion 221 are overlapped. The second fixing portion 221 is installed in the second installation space 120 of the second side wall 12. Under the action of the external force, the second base portion 222 can elastically deform relative to the second fixing portion 221.

In the first embodiment of the present disclosure, the second base portion 222 includes a third protrusion 2221, a fourth protrusion 2222, and two second locking arms 2223 located outside the third protrusion 2221 and the fourth protrusion 2222. In the first embodiment illustrated in the present disclosure, the third protrusion 2221 and the fourth protrusion 2222 are located on two sides of the second base portion 222, respectively. Each second locking arm 2223 is integrally formed with the second base portion 222 (for example, stamped in one piece). Each second locking arm 2223 is provided with a second locking hook portion 2223a configured to lock with the mating connector 200. The second locking arm 2223 is received in a corresponding second slot 1201, and is deformable to a certain extent in the corresponding second slot 1201.

The driving element 3 is connected to the first locking piece 21 and the second locking piece 22. The pull strap 4 is connected to the driving element 3. The pull strap 4 is capable of driving the driving element 3 to move under the action of the external force, thereby elastically deforming the first locking piece 21 and the second locking piece 22, so that the first locking hook portion 2123a and the second locking hook portion 2223a are unlocked from the mating connector 200.

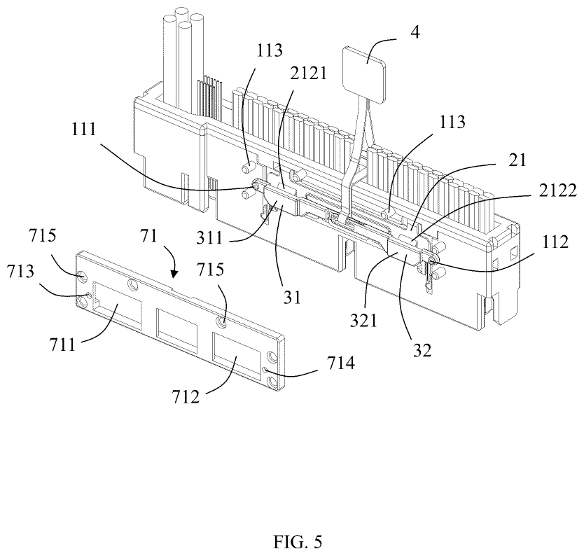

Referring to FIG. 5 to FIG. 13, in the first embodiment of the present disclosure, the driving element 3 includes a first pivot rod 31 at least partially installed on the first side wall 11, a second pivot rod 32 is at least partially installed on the first side wall 11, a third pivot rod 33 at least partially mounted on the second side wall 12, and a fourth pivot rod 34 at least partially mounted on the second side wall 12.

The pull strap 4 is capable of driving the first pivot rod 31 and the second pivot rod 32 to rotate relative to the first side wall 11, and is capable of driving the third pivot rod 33 and the fourth pivot rod 34 to rotate relative to the second side wall 12, under the driving of the external force. The first pivot rod 31 and the second pivot rod 32 press against the first locking piece 21 when rotating, so that the first locking hook portion 2123a is unlocked from the mating connector 200. The third pivot rod 33 and the fourth pivot rod 34 press against the second locking piece 22 when rotating, so that the second locking hook portion 2223a is unlocked from the mating connector 200.

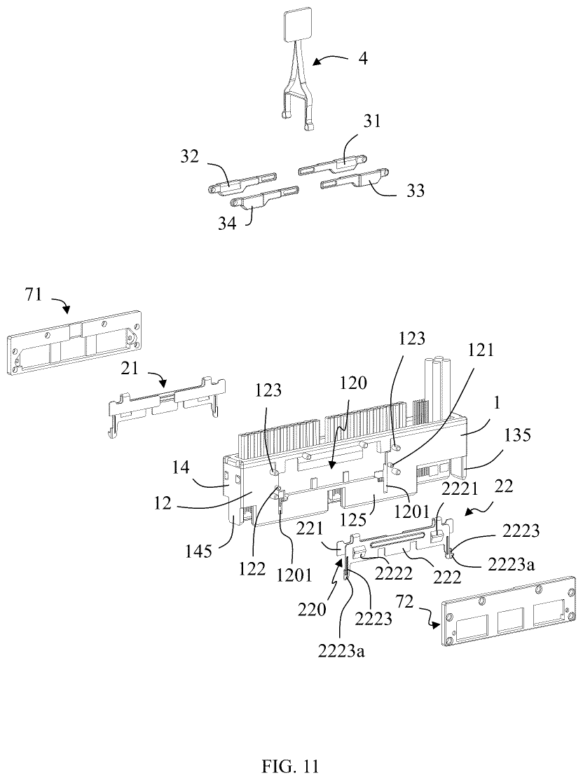

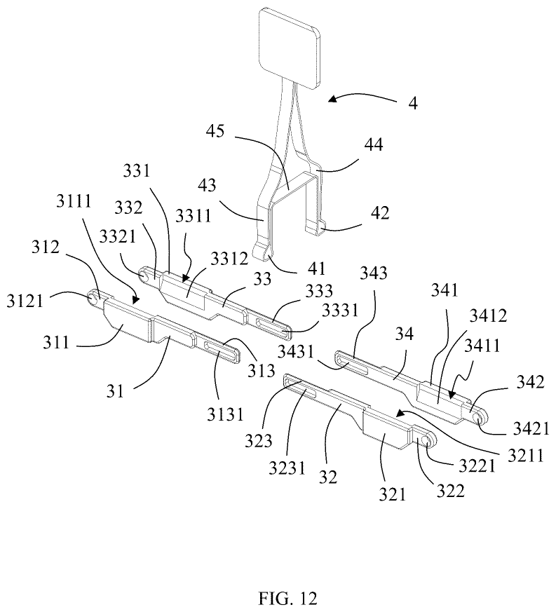

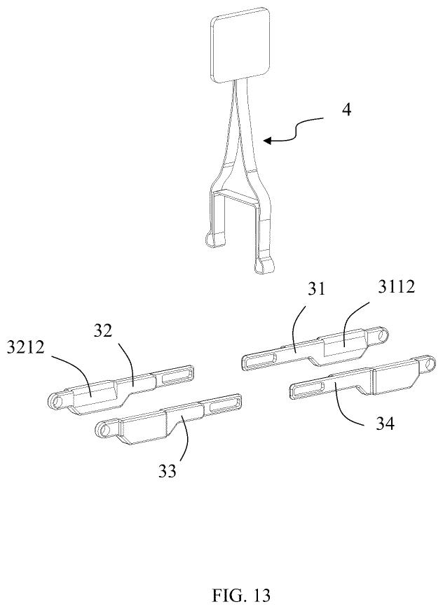

Referring to FIG. 12 and FIG. 13, in the first embodiment of the disclosure, the first pivot rod 31 is generally straight, and includes a first body portion 311, a first pivot portion 312 located on one side of the first body portion 311, and a first buckle portion 313 located on the other side of the first body portion 311. The second pivot rod 32 is generally straight, and includes a second body portion 321, a second pivot portion 322 located on one side of the second body portion 321, and a second buckle portion 323 located on the other side of the second body portion 321. The third pivot rod 33 is generally straight, and includes a third body portion 331, a third pivot portion 332 located on one side of the third body portion 331, and a third buckle portion 333 located on the other side of the third body portion 331. The fourth pivot rod 34 is generally straight, and includes a fourth body portion 341, a fourth pivot portion 342 located on one side of the fourth body portion 341, and a fourth buckle portion 343 located on the other side of the fourth body portion 341.

In the first embodiment illustrated in the present disclosure, the first body portion 311 protrudes outwardly compared to the first pivot portion 312 and the first buckle portion 313 which are located on two sides of the first body portion 311. An inner wall of the first body portion 311 (that is, the inner wall facing the first locking piece 21) includes a first receiving groove 3111 for receiving the first protrusion 2121, and a first inclined surface 3112 exposed in the first receiving groove 3111.

In the first embodiment illustrated in the present disclosure, the second body portion 321 protrudes outwardly compared to the second pivot portion 322 and the second buckle portion 323 which are located on two sides of the second body portion 321. An inner wall of the second body portion 321 (that is, the inner wall facing the first locking piece 21) includes a second receiving groove 3211 for receiving the second protrusion 2122, and a second inclined surface 3212 exposed in the second receiving groove 3211.

In the first embodiment of the present disclosure, the third body portion 331 protrudes outwardly compared to the third pivot portion 332 and the third buckle portion 333 which are located on two sides of the third body portion 331. An inner wall of the third body portion 331 (that is, the inner wall facing the second locking piece 22) includes a third receiving groove 3311 for receiving the third protrusion 2221, and a third inclined surface 3312 exposed in the third receiving groove 3311.

In the first embodiment illustrated in the present disclosure, the fourth body portion 341 protrudes outwardly compared to the fourth pivot portion 342 and the fourth buckle portion 343 which are located on two sides of the fourth body portion 341. An inner wall of the fourth body portion 341 (that is, the inner wall facing the second locking piece 22) includes a fourth receiving groove 3411 for receiving the fourth protrusion 2222, and a fourth inclined surface 3412 exposed in the fourth receiving groove 3411.

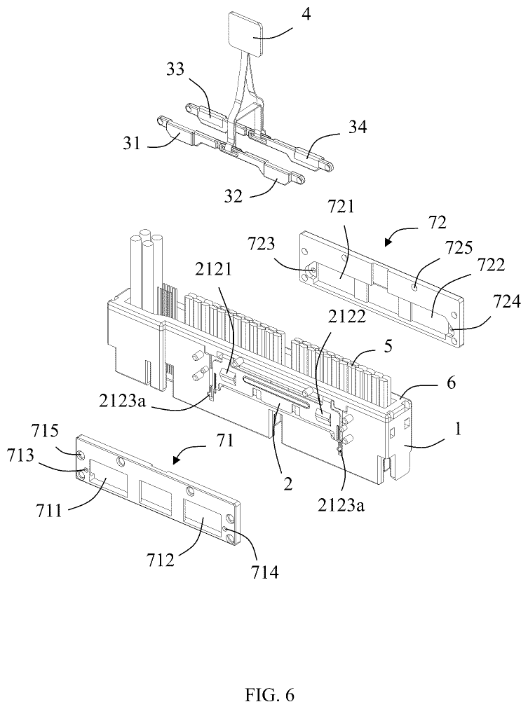

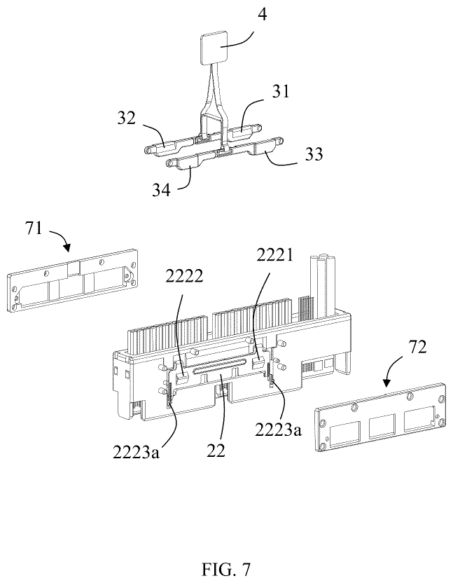

Referring to FIG. 6, FIG. 7 and FIG. 12, in the first embodiment of the present disclosure, the pull strap 4 is connected to the first buckle portion 313, the second buckle portion 323, and the third buckle portion 333 and the fourth buckle portion 343, so that the first pivot rod 31, the second pivot rod 32, the third pivot rod 33 and the fourth pivot rod 34 can be driven to move simultaneously. The pull strap 4 includes a first connecting portion 41 that connects the first buckle portion 313 and the second buckle portion 323 together, and a second connecting portion 42 that connects the third buckle portion 333 and the fourth buckle portion 343 together.

The first pivot rod 31 is capable of driving one of the first locking arms 2123 to move; and the second pivot rod 32 is capable of driving a remaining one of the first locking arms 2123 to move. The third pivot rod 33 is capable of driving one of the second locking arms 2223 to move; and the fourth pivot rod 34 is capable of driving a remaining one of the second locking arms 2223 to move.

Specifically, when the first pivot rod 31 is pulled by the pull strap 4 and rotates, the first inclined surface 3112 presses against the first protrusion 2121, so that the first base portion 212 is deformed in a direction closer to the first fixing portion 211 to achieve unlocking. In the same way, when the second pivot rod 32 is pulled by the pull strap 4 and rotates, the second inclined surface 3212 presses against the second protrusion 2122, so that the first base portion 212 is deformed in a direction closer to the first fixing portion 211 to achieve unlocking.

Similarly, when the third pivot rod 33 is pulled by the pull strap 4 and rotates, the third inclined surface 3312 press against the third protrusion 2221, so that the second base portion 222 is deformed in a direction closer to the second fixing portion 221 to achieve unlocking. In the same way, when the fourth pivot rod 34 is pulled by the pull strap 4 and rotates, the fourth inclined surface 3412 press against the fourth protrusion 2222, so that the second base portion 222 is deformed in a direction closer to the second fixing portion 221 to achieve unlocking.

Specifically, in the first embodiment of the present disclosure, the pull strap 4 further includes a first connecting belt 43 connected to the first connecting portion 41, a second connecting belt 44 connected to the second connecting portion 42, and a third connecting belt 45 connected to the first connecting portion 41 and the second connecting portion 42.

In the first embodiment of the disclosure, the first connecting portion 41 connects the first buckle portion 313 and the second buckle portion 323 together in a movable manner. The second connecting portion 42 connects the third buckle portion 333 and the fourth buckle portion 343 together in a movable matter.

Specifically, the first connecting belt 43 is connected to an outer layer of the first connecting portion 41. One end of the third connecting belt 45 is connected to an inner layer of the first connecting portion 41. The second connecting belt 44 is connected to an outer layer of the second connecting portion 42. The other end of the third connecting belt 45 is connected to an inner layer of the second connecting portion 42. The third connecting belt 45 is configured to be flexibly movable to adjust the positions of the first connecting portion 41 and the second connecting portion 42. When the external force exerted on the pull strap 4 is a tilting force, it is ensured that the external force can drive the first pivot rod 31, the second pivot rod 32, the third pivot rod 33 and the fourth pivot rod 34 at the same time or within a reasonably short period of time, thereby ultimately achieving double-sided unlocking.

In the first illustrated embodiment of the present disclosure, the first buckle portion 313 and the second buckle portion 323 are at least partially overlapped. The first buckle portion 313 defines a first slot 3131. The second buckle portion 323 defines a second slot 3231. The first connecting portion 41 passes through the first slot 3131 and the second slot 3231 to connect the first buckle portion 313 and the second buckle portion 323 together.

Similarly, the third buckle portion 333 and the fourth buckle portion 343 are at least partially overlapped. The third buckle portion 333 defines a third slot 3331. The fourth buckle portion 343 defines a fourth slot 3431. The second connecting portion 42 passes through the third slot 3331 and the fourth slot 3431 to connect the third buckle portion 333 and the fourth buckle portion 343 together.

In the first embodiment of the present disclosure, the first pivot portion 312 defines a first pivot hole 3121 that is sleeved on the first protruding post 111, so that the first pivot rod 31 is allowed to rotate to a certain extent relative to the first side wall 11. The second pivot portion 322 defines a second pivot hole 3221 that is sleeved on the second protruding post 112, so that the second pivot rod 32 is allowed to rotate to a certain extent relative to the first side wall 11. The third pivot portion 332 defines a third pivot hole 3321 that is sleeved on the third protruding post 121, so that the third pivot rod 33 is allowed to rotate to a certain extent relative to the second side wall 12. The fourth pivot portion 342 defines a fourth pivot hole 3421 that is sleeved on the fourth protruding post 122, so that the fourth pivot rod 34 is allowed to rotate to a certain extent relative to the second side wall 12. Of course, it is understandable o those skilled in the art that there are various ways to enable the first pivot rod 31 and the second pivot rod 32 to rotate relative to the first side wall 11 to a certain extent; and there are various ways to enable the third pivot rod 33 and the fourth pivot rod 34 to rotate relative to the second side wall 12 to a certain extent, which will not be described in detail in the present disclosure.

It is understandable to those skilled in the art that the pull strap connector 100 may not be provided with the driving element 3. Under this circumstance, the pull strap 4 is directly connected to the first locking piece 21 and the second locking piece 22.

The pull strap 4 includes a first connecting portion 41 that is connected to the first base portion 212 of the first locking piece 21, a second connecting portion 42 that is connected to the second base portion 222 of the second locking piece 22, a first connecting belt 43 connected to the first connecting portion 41, a second connecting belt 44 connected to the second connecting portion 42, and a third connecting belt 45 connecting the first connecting portion 41 and the second connecting portion 42.

The first connecting portion 41 is connected to the first base portion 212 in a movable manner; and the second connecting portion 42 is connected to the second base portion 222 in a movable manner. Specifically, the first connecting belt 43 is connected to an outer layer of the first connecting portion 41. One end of the third connecting belt 45 is connected to an inner layer of the first connecting portion 41. The second connecting belt 44 is connected to an outer layer of the second connecting portion 42. The other end of the third connecting belt 45 is connected to an inner layer of the second connecting portion 42. The third connecting belt 45 is configured to be flexibly movable to adjust the positions of the first connecting portion 41 and the second connecting portion 42. When the external force exerted on the pull strap 4 is a tilting force, it is ensured that the external force can drive the first locking piece 21 and the second locking piece 22 to elastically deform at the same time or in a reasonably short period of time. As a result, the first locking hook portion 2123a of the first locking arm 2123 and the second locking hook portion 2223a of the second locking arm 2223 are separated from the first locking hole 2031a and the second locking hole 2032a of the mating connector 200, respectively, to achieve simultaneous unlocking on two sides.

Referring to FIGS. 1 to 7, the pull strap connector 100 further includes a first pressing block 71 mounted and fixed to the first side wall 11 to limit the first pivot rod 31 and the second pivot rod 32, and a second pressing block 72 mounted and fixed to the second side wall 12 to limit the third pivot rod 33 and the fourth pivot rod 34. The first pressing block 71 defines a first relief groove 711, a second relief groove 712, a first mounting hole 713, a second mounting hole 714 and a plurality of first mounting positioning holes 715. The first mounting positioning holes 715 are sleeved on corresponding first mounting posts 113. The first pressing block 71 is fixed to the first side wall 11 by, for example, hot melting. The first mounting hole 713 is sleeved on the first protruding post 111. The second mounting hole 714 is sleeved on the second protruding post 112. The first body portion 311 at least partially protrudes into the first relief groove 711. The second body portion 321 at least partially protrudes into the second relief groove 712.

Similarly, the second pressing block 72 defines a third relief groove 721, a fourth relief groove 722, a third mounting hole 723, a fourth mounting hole 724 and a plurality of second mounting positioning holes 725. The second mounting positioning holes 725 are sleeved on corresponding second mounting posts 123. The second pressing block 72 is fixed to the second side wall 12 by, for example, hot melting. The third mounting hole 723 is sleeved on the third protruding post 121. The fourth mounting hole 724 is sleeved on the fourth protruding post 122. The third body portion 331 at least partially protrudes into the third relief groove 721. The fourth body portion 341 at least partially protrudes into the fourth relief groove 722.

As shown in FIG. 14, the cable module 5 includes a built-in circuit board 51 and a plurality of cables 52 connected to the built-in circuit board 51. In the illustrated embodiment of the present disclosure, the cable module 5 further includes an insulating block 53 over-molded on part of the built-in circuit board 51 and part of the plurality of cables 52. The cable module 5 is at least partially inserted into the installation groove 10. The built-in circuit board 51 includes a plug portion 511 that at least partially passes through the installation groove 10. The plug portion 511 is provided with a plurality of conductive pads 512 configured to electrically mate with the mating connector 200. In the illustrated embodiment of the present disclosure, the plurality of conductive pads 512 are distributed on two opposite surfaces of the plug portion 511.

The locking member 6 is locked with the insulating body 1 to fix the cable module 5. Specifically, in the illustrated embodiment of the present disclosure, the locking member 6 is provided with a body 61 and at least one locking elastic arm 62 extending from the body 61. The body 61 defines an opening 610 for the plurality of cables 52 to pass through. The insulating body 1 further includes at least one locking hole 15 communicating with the installation groove 10. The locking elastic arm 62 is locked in the locking hole 15. The body 61 presses against the insulating block 53 of the cable module 5 so as to fix the cable module 5 to the insulating body 1.

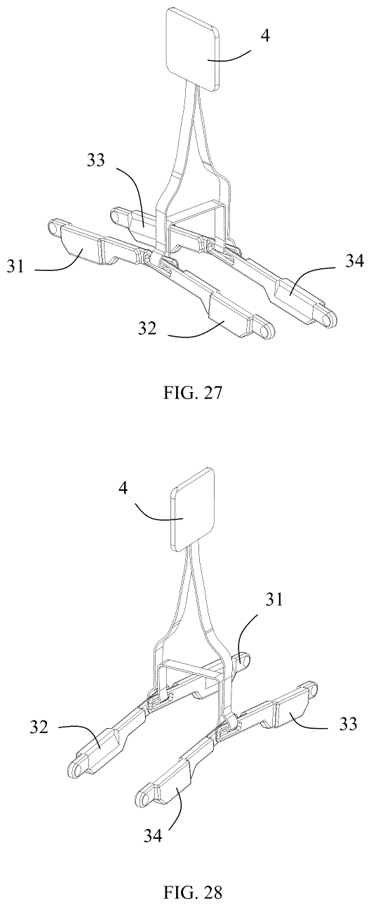

As shown in FIG. 5, FIG. 8 and FIG. 27, the unlocking method of the connector assembly in the illustrated first embodiment of the present disclosure is as follows: when unlocking is required, an external force pulls the pull strap 4; depending on the direction of the external force, the pull strap 4 may move appropriately to adjust the positions of the first connecting portion 41 and the second connecting portion 42; the component force of the external force along the direction perpendicular to the first pivot rod 31, the second pivot rod 32, the third pivot rod 33 and the fourth pivot rod 34 will drive the first pivot rod 31, the second pivot rod 32, the third pivot rod 33 and the fourth pivot rod 34 to rotate appropriately; and drives the first base portion 212 of the first locking piece 21 and the second base portion 222 of the second locking piece 22 to elastically deform; finally, the first locking hook portion 2123a of the first locking arm 2123 and the second locking hook portion 2223a of the second locking arm 2223 are separated from the first locking hole 2031a and the second locking hole 2032a of the mating connector 200, respectively, to achieve simultaneous unlocking on two sides.

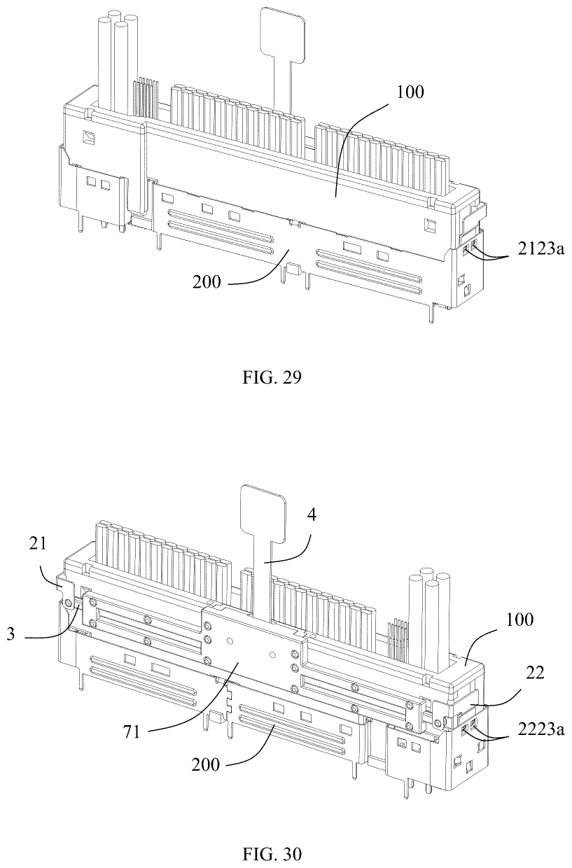

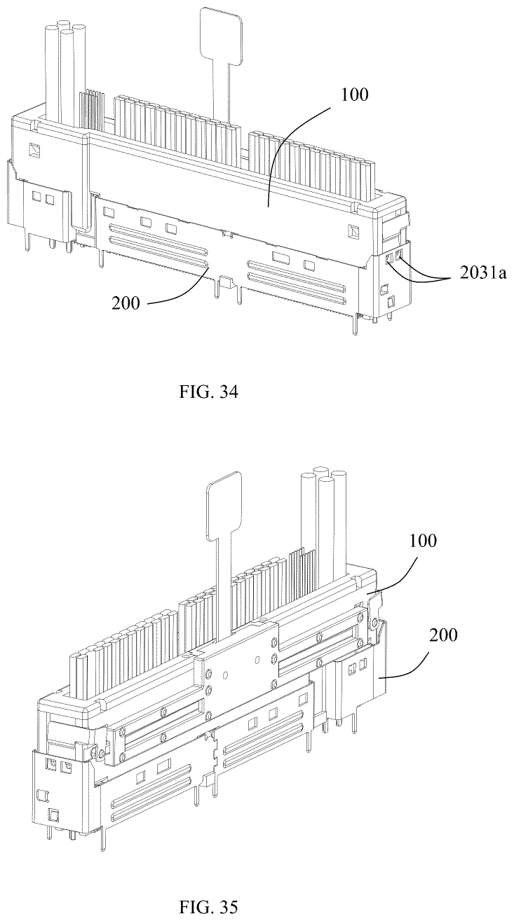

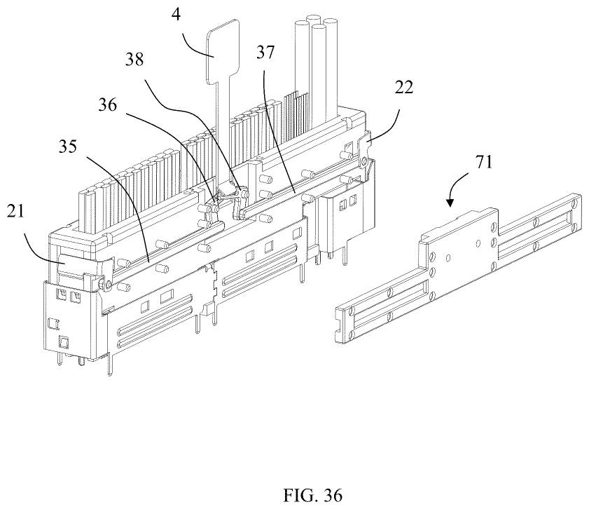

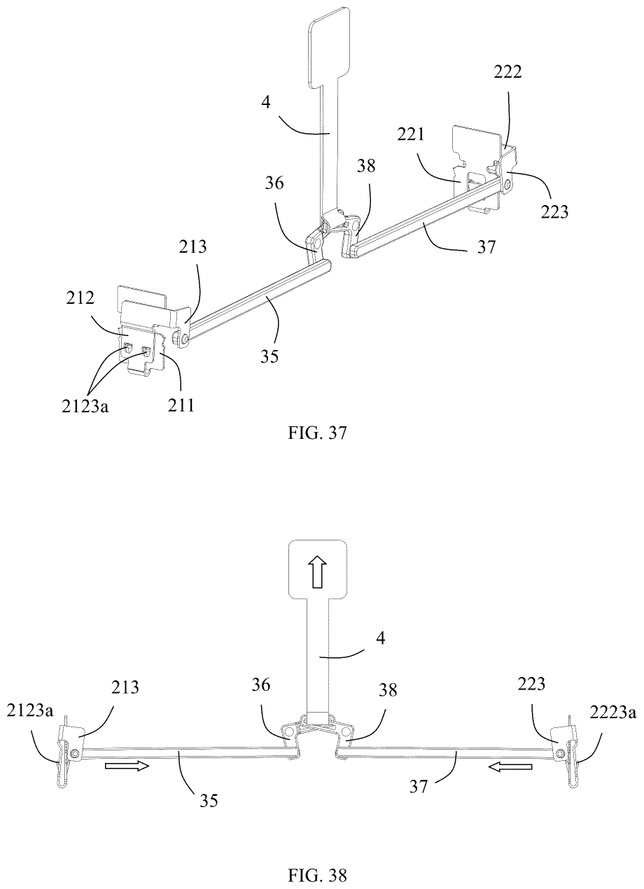

FIG. 29 to FIG. 38 illustrate a connector assembly in a second embodiment of the present disclosure. The connector assembly in the second embodiment includes a mating connector 200 and a pull strap connector 100 that mates with the mating connector 200 to transmit data/and/or power.

The mating connector 200 in the second embodiment of the present disclosure includes an insulating body portion 201, a plurality of terminal modules 202 installed in the insulating body portion 201, and a shell 203 enclosing the insulating body portion 201. The insulating body portion 201 defines a receiving slot 204 for receiving at least part of the pull strap connector 100. The shell 203 may be made of metal material, and includes a first wall portion 2031 and a second wall portion 2032 opposite to the first wall portion 2032. The first wall portion 2031 and the second wall portion 2032 are narrow sides of the shell 203. The first wall portion 2031 defines a first locking hole 2031a. The second wall portion 2032 defines a second locking hole 2032a.

In the second embodiment of the disclosure, the pull strap connector 100 includes an insulating body 1, a first locking piece 21, a second locking piece 22, a driving element 3, a pull strap 4, a cable module 5, and a locking member 6. In the illustrated second embodiment of the present disclosure, the first locking piece 21 and the second locking piece 22 are mounted to the insulating body 1.

The pull strap connector 100 in the second embodiment of the present disclosure may refer to the pull strap connector 100 in the first embodiment of the present disclosure as shown in FIG. 1 to FIG. 28. Same numerals represent the same or similar features, and only the main differences between the two are described in detail below.

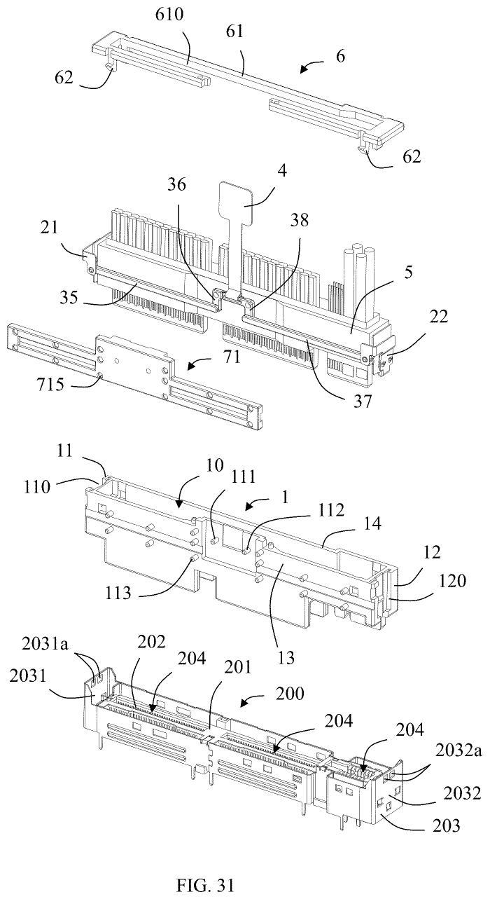

Referring to FIG. 31, in the second embodiment of the present disclosure, the insulating body 1 includes a first side wall 11, a second side wall 12 opposite to the first side wall 11, a third side wall 13, a fourth side wall 14 opposite to the third side wall 13, and an installation groove 10 jointly surrounded by the first side wall 11, the second side wall 12, the third side wall 13 and the fourth side wall 14. In the second embodiment illustrated in the present disclosure, the insulating body 1 is generally in the shape of a rectangular parallelepiped. The first side wall 11 and the second side wall 12 are the short sides of the rectangular parallelepiped. The third side wall 13 and the fourth side wall 14 are the long sides of the rectangular parallelepiped.

In the second embodiment of the present disclosure, the first side wall 11 defines a first installation space 110 for installing the first locking piece 21. The second side wall 12 defines a second installation space 120 for installing the second locking piece 22.

Besides, the third side wall 13 includes a first protruding post 111 protruding outwardly, a second protruding post 112 protruding outwardly, and a plurality of first mounting posts 113 protruding outwardly. The plurality of first mounting posts 113 are used to fix a first pressing block 71.

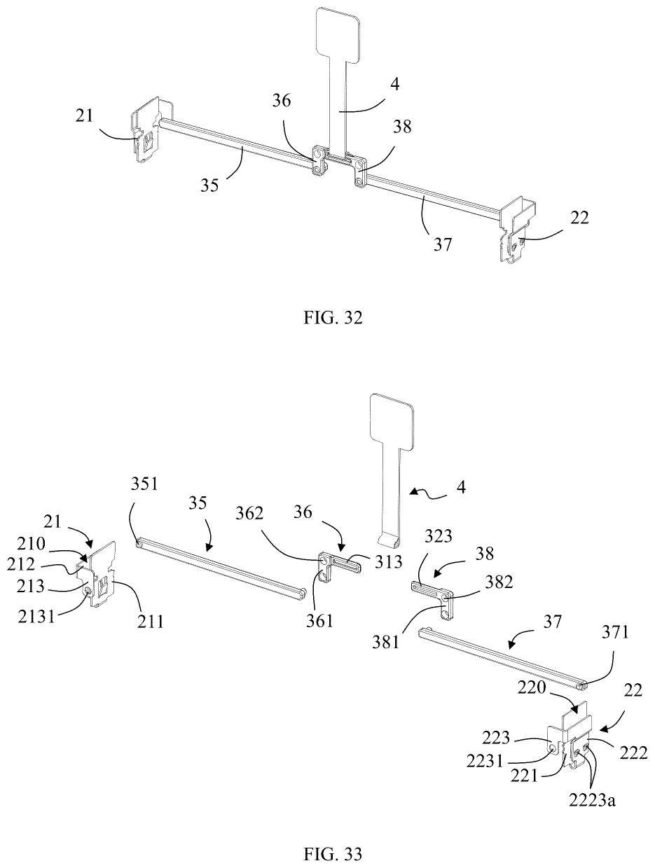

Referring to FIG. 32 to FIG. 38, in the second embodiment of the present disclosure, the first locking piece 21 is formed by stamping and bending a metal sheet. The first locking piece 21 is generally U-shaped, and includes a first fixing portion 211, a first base portion 212 folded from one side of the first fixing portion 211, a first deformation space 210 located between the first fixing portion 211 and the first base portion 212, and a first driving portion 213 extending from the first base portion 212. Most of the first base portion 212 and the first fixing portion 211 are overlapped. The first fixing portion 211 is installed in the first installation space 110 of the first side wall 11. The first base portion 212 is provided with at least one first locking hook portion 2123a. In the second embodiment illustrated in the present disclosure, two first locking hook portions 2123a are provided and stamped outwardly from the first base portion 212. The first driving portion 213 is capable of driving the first base portion 212 to elastically deform compared to the first fixing portion 211 so as to unlock the first locking hook portion 2123a from the mating connector 200.

Similarly, the second locking piece 22 is formed by stamping and bending a metal sheet. The second locking piece 22 is generally U-shaped, and includes a second fixing portion 221, a second base portion 222 folded from one side of the second fixing portion 221, a second deformation space 220 located between the second fixing portion 221 and the second base portion 222, and a second driving portion 223 extending from the second base portion 222. Most of the second base portion 222 and the second fixing portion 221 are overlapped. The second fixing portion 221 is installed in the second installation space 120 of the second side wall 12. The second base portion 222 is provided with at least one second locking hook portion 2223a. In the second embodiment illustrated in the present disclosure, two second locking hook portions 2223a are provided and stamped outwardly from the second base portion 222. The second driving portion 223 is capable of driving the second base portion 222 to elastically deform compared to the second fixing portion 221 so as to unlock the second locking hook portion 2223a from the mating connector 200.

In the second embodiment illustrated in the present disclosure, the first driving portion 213 is perpendicular to the first base portion 212. The second driving portion 223 is perpendicular to the second base portion 222. The first driving portion 213 and the second driving portion 223 are located on a same side of the insulating body 1 (for example, located on one side of the third side wall 13). In the second embodiment of the present disclosure, the first driving portion 213 defines a first through hole 2131. The second driving portion 223 defines a second through hole 2231.

In the second embodiment of the present disclosure, the driving element 3 includes a first connecting rod 35 connected to the first driving portion 213, a second connecting rod 36 cooperating with the first connecting rod 35, a third connecting rod 37 connected to the second driving portion 223, and a fourth connecting rod 38 cooperating with the third connecting rod 37. The second rod 36 includes a first buckle portion 313. The fourth rod 38 includes a second buckle portion 323. The pull strap 4 is connected to the first buckle portion 313 and the second buckle portion 323. In the second embodiment of the disclosure, the first connecting rod 35 and the third connecting rod 37 are substantially straight. The second connecting rod 36 and the fourth connecting rod 38 are generally L-shaped.

The second rod 36 is rotatably mounted to the insulating body 1. The first rod 35 is rotatably connected to the second rod 36. The fourth rod 38 is rotatably mounted to the insulating body 1. The third rod 37 is rotatably connected to the fourth rod 38.

Specifically, in the second embodiment of the present disclosure, the second rod 36 includes a first mounting rod 361 connected to the first buckle portion 313. The first mounting rod 361 is perpendicular to the first buckle portion 313. The second rod 36 includes a first pivot hole 362 located at a junction of the first buckle portion 313 and the first mounting rod 361. The first pivot hole 362 is configured to mate with the insulating body 1. The first mounting rod 361 is rotatably connected to one end of the first connecting rod 35, and the other end of the first connecting rod 35 is connected to the first driving portion 213. In the second embodiment of the present disclosure, the first pivot hole 362 is sleeved on the first protruding post 111 so that the second rod 36 is rotatable appropriately relative to the insulating body 1. In the second embodiment illustrated in the present disclosure, the first mounting rod 361 is rotatably connected to one end of the first connecting rod 35 through a protruding post and a through hole. The other end of the first connecting rod 35 is provided with a first convex post 351 fixed to the first through hole 2131.

The fourth rod 38 includes a second mounting rod 381 connected to the second buckle portion 323. The second mounting rod 381 is perpendicular to the second buckle portion 323. The fourth rod 38 includes a second pivot hole 382 located at a junction of the second buckle portion 323 and the second mounting rod 381. The second pivot hole 382 is configured to mate with the insulating body 1. The second mounting rod 381 is rotatably connected to one end of the third rod 37, and the other end of the third rod 37 is connected to the second driving portion 223. In the second embodiment of the present disclosure, the second pivot hole 382 is sleeved on the second protruding post 112, so that the fourth rod 38 is rotatable appropriately relative to the insulating body 1. In the second embodiment illustrated in the present disclosure, the second mounting rod 381 and one end of the third connecting rod 37 are rotatably connected through a protruding post and a through hole. The other end of the third connecting rod 37 is provided with a second convex post 371 fixed to the second through hole 2231.

The unlocking method of the connector assembly in the illustrated second embodiment of the present disclosure is as follows: when unlocking is required, an external force pulls the pull strap 4; the component force of the external force perpendicular to the first buckle portion 313 and the second buckle portion 323 will drive the second link 36 and the fourth link 38 to rotate appropriately around the first protruding post 111 and the second protruding post 112, respectively; and drive the first connecting rod 35 and the third connecting rod 37 to move inwardly; the first connecting rod 35 and the third connecting rod 37 respectively drive the first base portion 212 of the first locking piece 21 and the second base portion 222 of the second locking piece 22 to elastically deform; finally, the first locking hook portion 2123a and the second locking hook portion 2223a are separated from the first locking hole 2031a and the second locking hole 2032a of the mating connector 200, respectively, to achieve simultaneous unlocking on two sides.

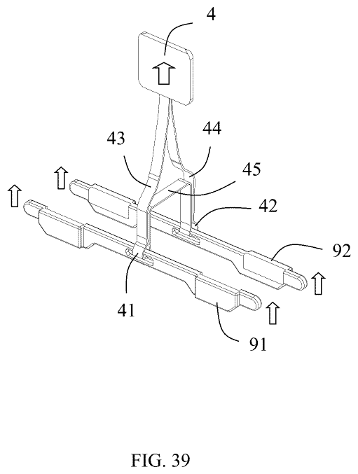

Referring to FIG. 6 and FIG. 39, it is understandable to those skilled in the art that the pull strap connector 100 in the first embodiment of the present disclosure can be appropriately modified, and the purpose of the present disclosure can also be achieved. For example, the first pivot rod 31 and the second pivot rod 32 shown in FIG. 6 are made into an integral first moving rod 91. The pull strap 4 is connected to the first moving rod 91. The first moving rod 91 is configured to slide up and down along a pulling direction of the pull strap 4. Similarly, the third pivot rod 33 and the fourth pivot rod 34 shown in FIG. 6 are made into an integral second moving rod 92. The pull strap 4 is connected to the second moving rod 92. The second moving rod 92 is configured to slide up and down along the pulling direction of the pull strap 4. At this time, when unlocking is required, a pulling force is applied to the pull strap 4, and the pulling force drives the first moving rod 91 and the second moving rod 92 to slide. At this time, the first moving rod 91 and the second moving rod 92 press against the first base portion 212 of the first locking piece 21 and the second base portion 222 of the second locking piece 22, respectively, so that the first base portion 212 of the first locking piece 21 and the second base portion 222 of the second locking piece 22 are elastically deformed. Finally, the first locking hook portion 2123a and the second locking hook portion 2223a are separated from the first locking hole 2031a and the second locking hole 2032a of the mating connector 200, respectively; and simultaneous unlocking of two sides can also be achieved.

As shown in FIG. 39, the pull strap 4 includes a first connecting portion 41 connected to the first moving rod 91, a second connecting portion 42 connected to the second moving rod 92, a first connecting belt 43 connected to the first connecting portion 41, a second connecting belt 44 connected to the second connecting portion 42, and a third connecting belt 45 connecting the first connecting portion 41 and the second connecting portion 42.

The first connecting portion 41 is connected to the first moving rod 91 in a movable manner. The second connecting portion 42 is connected to the second moving rod 92 in a movable manner. Specifically, the first connecting belt 43 is connected to an outer layer of the first connecting portion 41. One end of the third connecting belt 45 is connected to an inner layer of the first connecting portion 41. The second connecting belt 44 is connected to an outer layer of the second connecting portion 42. The other end of the third connecting belt 45 is connected to an inner layer of the second connecting portion 42. The third connecting belt 45 is configured to be flexibly movable to adjust the positions of the first connecting portion 41 and the second connecting portion 42. When the external force exerted on the pull strap 4 is a tilting force, it is ensured that the external force can drive the first moving rod 91 and the second moving rod 92 to slide at the same time or within a reasonably short time, so as to finally achieve double-sided unlocking.

It is understandable to those skilled in the art that the first moving rod 91 and the second moving rod 92 shown in FIG. 39 can be made into an integral moving rod. The moving rod is installed inside the insulating body 1. The moving rod is capable of elastically deforming the first locking piece 21 and the second locking piece 22 under the pull of the pull strap 4. Finally, the first locking hook portion 2123a and the second locking hook portion 2223a are separated from the first locking hole 2031a and the second locking hole 2032a of the mating connector 200, respectively; and simultaneous unlocking of two sides can also be achieved.

The above embodiments are only used to illustrate the present disclosure and not to limit the technical solutions described in the present disclosure. The understanding of this specification should be based on those skilled in the art. Descriptions of directions, although they have been described in detail in the above-mentioned embodiments of the present disclosure, those skilled in the art should understand that modifications or equivalent substitutions can still be made to the application, and all technical solutions and improvements that do not depart from the spirit and scope of the application should be covered by the claims of the application.

What is claimed is:

1. A pull strap connector, configured to mate with a mating connector, comprising:
an insulating body, the insulating body comprising a first side wall and a second side wall opposite to the first side wall;
a first locking piece, the first locking piece being at least partially mounted to the first side wall; the first locking piece comprising a first locking hook portion configured to lock with the mating connector;
a second locking piece, the second locking piece being at least partially mounted to the second side wall; the second locking piece comprising a second locking hook portion configured to lock with the mating connector; and
a pull strap, the pull strap directly or indirectly driving the first locking piece and the second locking piece;
wherein the pull strap is configured to be pulled by an external force, so that the first locking hook portion and the second locking hook portion are unlocked from the mating connector.

2. The pull strap connector according to claim 1, wherein the pull strap comprises a first connecting portion movably connected to the first locking piece and a second connecting portion movably connected to the second locking piece; the first connecting portion and the second connecting portion are configured to adjust their positions under an action of the external force, so that the first locking hook portion and the second locking hook portion are unlocked from the mating connector.

3. The pull strap connector according to claim 1, further comprising a driving element connected to the first locking piece and the second locking piece; the pull strap being connected to the driving element;
wherein the pull strap is configured to drive the driving element to move under an action of external force, thereby causing the first locking piece and the second locking piece to deform elastically, so that the first locking hook portion and the second locking hook portion are unlocked from the mating connector.

4. The pull strap connector according to claim 3, wherein the driving element comprises a first pivot rod at least partially mounted to the first side wall and a second pivot rod at least partially mounted to the first side wall; the first pivot rod comprises a first buckle portion; the second pivot rod comprises a second buckle portion;
the driving element further comprises a third pivot rod at least partially mounted to the second side wall and a fourth pivot rod at least partially mounted to the second side wall; the third pivot rod comprises a third buckle portion; the fourth pivot rod comprises a fourth buckle portion;
the pull strap comprises a first connecting portion and a second connecting portion; the first connecting portion movably connects the first buckle portion and the second buckle portion together; the second connecting portion movably connects the third buckle portion and the fourth buckle portion together; the first connecting portion and the second connecting portion are configured to adjust their positions under the action of the external force, so that the first locking hook portion and the second locking hook portion are unlocked from the mating connector.

5. The pull strap connector according to claim 3, wherein the first locking piece comprises two first locking arms disposed side by side; each first locking arm comprises one first locking hook portion;
the second locking piece comprises two second locking arms disposed side by side; each second locking arm comprises one second locking hook portion;
the driving element comprises a first pivot rod at least partially mounted to the first side wall, a second pivot rod at least partially mounted to the first side wall, a third pivot rod at least partially mounted to the second side wall, and a fourth pivot rod at least partially mounted to the second side wall;
the pull strap is configured to rotate the first pivot rod and the second pivot rod relative to the first side wall, and to rotate the third pivot rod and the fourth pivot rod relative to the second side wall, under the action of the external force;
the first pivot rod and the second pivot rod are configured to press the first locking piece when rotating, so that the first locking hook portion is unlocked from the mating connector;
the third pivot rod and the fourth pivot rod are configured to press the second locking piece when rotating, so that the second locking hook portion is unlocked from the mating connector.

6. The pull strap connector according to claim 5, wherein the first pivot rod comprises a first body portion, a first pivot portion located on one side of the first body portion, and a first buckle portion located on another side of the first body portion;
the second pivot rod comprises a second body portion, a second pivot portion located on one side of the second body portion, and a second buckle portion located on another side of the second body portion;
the third pivot rod comprises a third body portion, a third pivot portion located on one side of the third body portion, and a third buckle portion located on another side of the third body portion;
the fourth pivot rod comprises a fourth body portion, a fourth pivot portion located on one side of the fourth body portion, and a fourth buckle portion located on another side of the fourth body portion;
the pull strap is connected to the first buckle portion, the second buckle portion, the third buckle portion and the fourth buckle portion.

7. The pull strap connector according to claim 6, wherein the first pivot rod is configured to drive one of the first locking arms to move, and the second pivot rod is configured to drive a remaining one of the first locking arms to move;
the third pivot rod is configured to drive one of the second locking arms to move, and the fourth pivot rod is configured to drive a remaining one of the second locking arm to move;
the pull strap comprises a first connecting portion that connects the first buckle portion and the second buckle portion together, and a second connecting portion that connects the third buckle portion and the fourth buckle portion together.

8. The pull strap connector according to claim 7, wherein the pull strap comprises a first connecting belt connected to the first connecting portion, a second connecting belt connected to the second connecting portion, and a third connecting belt connecting the first connecting portion and the second connecting portion;
the first connecting portion connects the first buckle portion and the second buckle portion together in a movable manner; the second connecting portion connects the third buckle portion and the fourth buckle portion together in a movable manner.

9. The pull strap connector according to claim 8, wherein the first connecting belt is connected to an outer layer of the first connecting portion; one end of the third connecting belt is connected to an inner layer of the first connecting portion;
the second connecting belt is connected to an outer layer of the second connecting portion;
another end of the third connecting belt is connected to an inner layer of the second connecting portion;
the third connecting belt is configured to adjust their positions of the first connecting portion and the second connecting portion.

10. The pull strap connector according to claim 7, wherein the first locking piece comprises a first fixing portion, a first base portion folded from one side of the first fixing portion, and a first deformation space located between the first fixing portion and the first base portion; the first fixing portion is mounted to the first side wall; the first base portion is elastically deformable relative to the first fixing portion; the two first locking arms are provided on two sides of the first base portion; the first base portion comprises a first protrusion and a second protrusion;
the second locking piece comprises a second fixing portion, a second base portion folded from one side of the second fixing portion, and a second deformation space located between the second fixing portion and the second base portion; the second fixing portion is mounted to the second side wall; the second base portion is elastically deformable relative to the second fixing portion; the two second locking arms are provided on two sides of the second base portion; the second base portion comprises a third protrusion and a fourth protrusion;
when the first pivot rod and the second pivot rod rotate, the first protrusion is pressed against by the first body portion, and the second protrusion is pressed against by the second body portion, so that the first base portion is elastically deformed relative to the first fixing portion;
when the third pivot rod and the fourth pivot rod rotate, the third protrusion is pressed against by the third body portion, and the fourth protrusion is pressed against by the fourth body portion, so that the second base portion is elastically deformed relative to the second fixing portion.

11. The pull strap connector according to claim 10, wherein the first body portion comprises a first inclined surface; the second body portion comprises a second inclined surface; the third body portion comprises a third inclined surface; the fourth body portion comprises a fourth inclined surface;
when the first pivot rod and the second pivot rod rotate, the first inclined surface presses against the first protrusion, and the second inclined surface presses against the second protrusion, so that the first base portion is elastically deformed relative to the first fixing portion;
when the third pivot rod and the fourth pivot rod rotate, the third inclined surface presses against the third abutment protrusion, and the fourth inclined surface presses against the fourth protrusion, so that the second base portion is elastically deformed relative to the second fixing portion.

12. The pull strap connector according to claim 10, further comprising a first pressing block mounted and fixed to the first side wall so as to limit the first pivot rod and the second pivot rod, and a second pressing block mounted and fixed to the second side wall to limit the third pivot rod and the fourth pivot rod;
the first pressing block defines a first relief groove and a second relief groove; the first body portion at least partially protrudes into the first relief groove; the second body portion at least partially protrudes into the second relief groove;
the second pressing block defines a third relief groove and a fourth relief groove; the third body portion at least partially protrudes into the third relief groove; the fourth body portion at least partially protrudes into the fourth relief groove.

13. The pull strap connector according to claim 3, wherein the first locking piece comprises a first fixing portion, a first base portion folded from one side of the first fixing portion, a first deformation space located between the first fixing portion and the first base portion, and a first driving portion extending from the first base portion; the first fixing portion is mounted to the first side wall; the first locking hook portion is provided on the first base portion; the first driving portion is configured to drive the first base portion to elastically deform relative to the first fixing portion, so that the first locking hook portion is unlocked from the mating connector;
the second locking piece comprises a second fixing portion, a second base portion folded from one side of the second fixing portion, a second deformation space located between the second fixing portion and the second base portion, and a second driving portion extending from the second base portion; the second fixing portion is mounted to the second side wall; the second locking hook portion is provided on the second base portion; the second driving portion is configured to drive the second base portion to elastically deform relative to the second fixing portion, so that the second locking hook portion is unlocked from the mating connector.

14. The pull strap connector according to claim 13, wherein the first driving portion is perpendicular to the first base portion; the second driving portion is perpendicular to the second base portion; and the first driving portion and the second driving portion are located on a same side of the insulating body.

15. The pull strap connector according to claim 14, wherein the driving element comprises a first connecting rod connected to the first driving portion, a second connecting rod mating with the first connecting rod, a third connecting rod connected to the second driving portion, and a fourth connecting rod mating with the third connecting rod; the second connecting rod comprises a first buckle portion; the fourth connecting rod comprises a second buckle portion; the pull strap is connected to the first buckle portion and the second buckle portion.

16. The pull strap connector according to claim 15, wherein the second connecting rod is rotatably mounted to the insulating body; the first connecting rod is rotatably connected to the second connecting rod;
the fourth connecting rod is rotatably mounted to the insulating body; the third connecting rod is rotatably connected to the fourth connecting rod.

17. The pull strap connector according to claim 16, wherein the second connecting rod comprises a first mounting rod connected to the first buckle portion; the first mounting rod is perpendicular to the first buckle portion; the second connecting rod defines a first pivot hole located at a junction of the first buckle portion and the first mounting rod; the first pivot hole is configured to mate with the insulating body; the first mounting rod is rotatably connected to one end of the first connecting rod; another end of the first connecting rod is connected to the first driving portion;
the fourth connecting rod comprises a second mounting rod connected to the second buckle portion; the second mounting rod is perpendicular to the second buckle portion; the fourth connecting rod defines a second pivot hole located at a junction of the second buckle portion and the second mounting rod; the second pivot hole is configured to mate with the insulating body;
the second mounting rod is rotatably connected to one end of the third connecting rod; another end of the third connecting rod is connected to the second driving portion.

18. The pull strap connector according to claim 1, further comprising a driving element which comprises a moving rod; the pull strap is connected to the moving rod;
wherein the moving rod is configured to press against the first locking piece and the second locking piece when sliding; and
wherein the pull strap is configured to drive the moving rod to slide under an action of the external force, thereby elastically deforming the first locking piece and the second locking piece, so that the first locking hook portion and the second locking hook portion are unlocked from the mating connector.

19. The pull strap connector according to claim 18, wherein the moving rod comprises a first moving rod mating with the first locking piece and a second moving rod mating with the second locking piece;
the pull strap comprises a first connecting portion and a second connecting portion; the first connecting portion is connected to the first moving rod in a movable manner; the second connecting portion is connected to the second moving rod in a movable manner; the first connecting portion and the second connecting portion are configured to adjust their positions under the action of the external force, so that the first locking hook portion and the second locking hook portion are unlocked from the mating connector.

20. A connector assembly, comprising:
a pull strap connector comprising:
an insulating body;
a first locking piece comprising a first locking hook portion configured to lock with the mating connector;
a second locking piece comprising a second locking hook portion configured to lock with the mating connector; the first locking hook portion and the second locking hook portion being located on opposite sides of the insulating body, respectively; and
a pull strap directly or indirectly driving the first locking piece and the second locking piece to deform; and
a mating connector comprising:
a shell comprising a first wall portion and a second wall portion opposite to the first wall portion; the first wall portion defining a first locking hole that matches the first locking hook portion; the second wall portion defining a second locking hole that matches the second locking hook portion; and
a receiving slot configured to receive at least part of the pull strap connector;
wherein the pull strap is configured to be pulled by an external force, so that the first locking hook portion and the second locking hook portion are unlocked from the mating connector.
